(19) United States
(12) Patent Application Publication
(10) Pub. No.: US 2022/0187528 A1
(43) Pub. Date: Jun. 16, 2022

(54) BACKLIGHT MODULE AND DISPLAY PANEL

(71) Applicant: Wuhan China Star Optoelectronics Technology Co., Ltd., Wuhan (CN)

(72) Inventor: Zheng ZHOU, Wuhan (CN)

(21) Appl. No.: 16/630,475

(22) PCT Filed: Nov. 6, 2019
(86) PCT No.: PCT/CN2019/116083

§ 371 Date: Jan. 13, 2020

(30) Foreign Application Priority Data
Aug. 14, 2019 (CN) 201910748382.9

(51) Int. Cl. F21V 8/00

(52) U.S. Cl. CPC G02B 6/0055; G02B 6/0088

(57) ABSTRACT

The present invention provides a backlight module and a display panel. The backlight module includes an optical film set, a light guide plate, a reflective sheet, and a bottom plate in turn, and further includes a frame connected to the bottom plate and disposed opposite to a side of the light guide plate. Wherein a gap is between one end of the optical film set and the frame.

### FIELD OF INVENTION

The present invention relates to the field of display, and in particular, to a backlight module and a display panel.

### BACKGROUND OF INVENTION

With the development of in-vehicle display technology, appearance requirements of in-vehicle display modules are also getting higher and higher, and requirements for frames of in-vehicle LTPS (low temperature poly silicon) display modules are becoming narrower and narrower.

Due to high reliability requirements of the in-vehicle displays, if optical film sets in backlights are not fixed, there will be a problem that backlight modules have abnormal sounds when shaking, and when the optical film sets and light guide plates rub against each other during vibration, the optical film sets and the light guide plates are scratched to cause optical defects. Optical films due to material problems (such as PET substrate) will expand at high temperatures, if spaces between the optical films and frames are not enough, the film expansion will be blocked and wrinkled, causing optical defects.

A conventional fixing method of a film is to design a boss in a thickness direction of a light guide plate and fix the film with both sides. The closer the boss of the guide plate is to a visual area (VA), the easier it is to cause a VA edge to be bright. Therefore, the conventional fixing method is limited for project requirements of narrow frame types.

### Technical Problem

The object of the present invention is to solve technical problems that fixing modes of optical film sets in current in-vehicle display screen are easy to produce bright sides at visual area (VA) edges of a display screen.

### Technical Solution

To achieve the above objective, the present invention provides a backlight module comprising an optical film set, a light guide plate, a reflective sheet, and a bottom plate in turn, and further comprising a frame connected to the bottom plate and disposed opposite to a side of the light guide plate. Wherein a gap is between one end of the optical film set and the frame.

Further, the reflective sheet comprises a first reflective sheet and a second reflective sheet that are integrated with each other. Wherein the first reflective sheet is attached to a bottom surface of the light guide plate, and the second reflective sheet is attached to a side of the light guide plate and is disposed opposite to the frame.

Further, the optical film set comprises a first optical film set and a second optical film set that are integrated with each other. Wherein the first optical film set is attached to a top surface of the light guide plate, and the second optical film set is attached to an outer surface of the second reflective sheet.

Further, the gap is disposed on a side of the first optical film set and opposite to the second optical film set.

Further, a width of the gap is greater than a thickness of the second reflective sheet, and the width of the gap is smaller than a width of a gap between the frame and the second reflective sheet.

Further, the optical film set comprises a first optical film attached to a surface of the light guide plate away from a side of the reflective sheet and extending to a side of the light guide plate; a second optical film attached to an outer surface of the first optical film; and a third optical film attached to an outer surface of the second optical film.

Further, bottoms of the first optical film, the second optical film, and the third optical film are on the same line.

Further, a bottom of the second optical film is lower than a bottom of the first optical film, and the bottom of the second optical film is fixed to an outer surface of the second reflective sheet; and a bottom of the third optical film is lower than the bottom of the second optical film, and the bottom of the third optical film is fixed to the outer surface of the second reflective sheet.

Further, the bottom plate comprises a first bottom plate attached to a bottom surface of the reflective sheet; and a second bottom plate disposed on an outer side of the second reflective sheet and disposed opposite to the second reflective sheet.

To achieve the above object, the present invention further provides a display panel comprising a backlight module as mentioned above.

### Beneficial Effect

The technical effect of the present invention is to provide gaps between a bottom plate and an optical film set, and between a frame and an optical film set. After a thermal expansion of the optical film set, one end of an elongated optical film set enters to the gaps, so that the optical film set is kept flat, and is attached to a light-emitting surface of the light guide plate to ensure that light from the light guide plate is normally transmitted through the optical film set. Further, the present invention can also extend service life of the optical film set, thereby extending the service life of an in-vehicle display panel.

### DESCRIPTION OF DRAWINGS

FIG. 1 is a schematic structural view of a backlight module according to an embodiment of the present invention.

FIG. 2 is a schematic structural view of an optical film set according to the embodiment of the present invention.

FIG. 3 is a schematic structural view of another backlight module according to an embodiment of the present invention.

Some Reference Numerals are as Follows:

1: optical film set; 2: light guide plate; 3: reflective sheet; 4: bottom plate; 5: frame; 11: first optical film set; 12: second optical film set; 101: first optical film; 102: second optical film; 103: third optical film; 31: first reflective sheet; 32: second reflective sheet; 41: first bottom plate; 42: second bottom plate; 51: first frame; 52: second frame; 61: first gap; 62: second gap.

### DETAILED DESCRIPTION OF PREFERRED EMBODIMENTS

Preferred embodiments of the present invention will be described in detail below with reference to the accompanying drawings, which will fully introduce the technical content of the present invention to those skilled in the art, and prove that the invention can be implemented by examples. The technical content of the present disclosure is made clearer, making it easier for those skilled in the art to understand how to implement the present invention. However, the invention can be embodied in many different forms of embodiment. The protection scope of the present invention is not limited to the embodiments mentioned herein. The following description of the embodiments is not intended to limit the scope of the invention.

The directional terms mentioned in the present invention, such as “upper”, “lower”, “before”, “after”, “left”, “right”, “inside”, “outside”, “side”, etc., are only directions in the drawings. The directional terms used herein are used to explain and describe the present invention and are not intended to limit the scope of the present invention.

In the drawings, components having the same structure are denoted by the same reference numerals. Components that are structurally or functionally similar are represented by like numerals. Moreover, dimensions and thickness of each component shown in the drawings are arbitrarily shown for ease of understanding and description. The invention does not limit the size and thickness of each component.

When a component is described as “on” another component, the component can be placed directly on the other component. There may also be an intermediate component on which the component is placed and the intermediate component placed on another component. When a component is described as “installed to” or “connected to” another component, it can be understood as either “installing” or “connecting” directly, or a component is “installed” or “connected” to another component through an intermediate component.

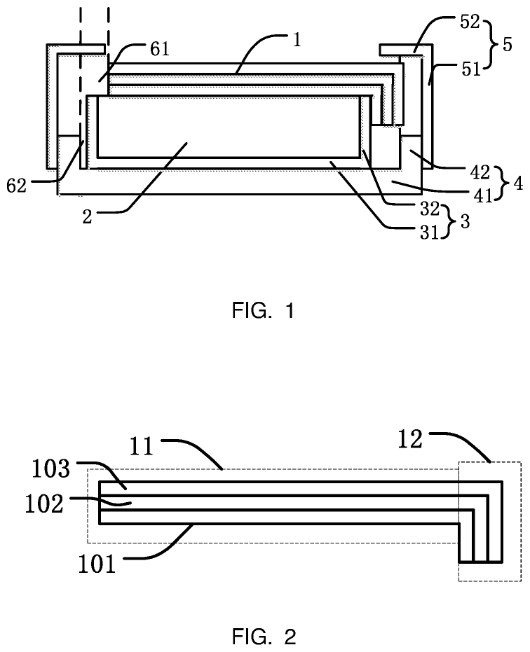

An embodiment of the present invention provides a display panel comprising a backlight module as shown in FIG. 1. The backlight module comprises an optical film set 1, a light guide plate 2, a reflective sheet 3, a bottom plate 4, and a frame 5.

The reflective sheet 3 can be attached to a bottom surface and a side surface of the light guide plate 2 by a transparent double-sided tape or glue. The reflective sheet 3 comprises two types: a silver reflective sheet and a white reflective sheet for totally reflecting light emitted from the light guide plate 2, so that the light is reused to reduce light loss.

The reflective sheet 3 comprises a first reflective sheet 31 and a second reflective sheet 32 that are integrated with each other. The first reflective sheet 31 is attached to the bottom surface of the light guide plate 2, and the second reflective sheet 32 is attached to the side surface of the light guide plate 2 and is disposed opposite to the frame 5. The second reflective sheet 32 is vertically connected to the first reflective sheet 31, and forms a L-shaped reflective sheet with the first reflective sheet 31. The reflective sheet 3 is divided into two parts to cover the bottom surface and the side surface of the light guide plate 2, respectively, so that the light entering the light guide plate 2 is totally reflected at positions where the first reflective sheet 31 and the second reflective sheet 32 are arranged, and the light is emitted from a light exit surface of the light guide plate 2.

A length of the second reflective sheet 32 is equivalent to a sum of a thickness of the light guide plate 2 and a thickness of the first reflective sheet 31, That is, the side surface of the light guide plate 2 is completely covered by the second reflective sheet 32, so that the side surface of the light guide plate 2 does not leave a gap. This ensures that the light entering the light guide plate 2 can be reflected by the second reflective sheet 32 after the side surface of the light guide plate 2, and the light is emitted from the light exit surface of the light guide plate 2, and is emitted from the optical film set 1 to improve a reflectivity and an emission rate of the light to further increase the brightness of the display panel.

The second reflective sheet 32 is generally attached to surfaces of three non-light-emitting sides of the light guide plate 2. That is, only one side opposite to the light source is not attached with the second reflection sheet 32. However, the second reflective sheet 32 may be attached to the surface of the light source away from the light guide plate 2, so that a small portion of the light behind the light source is reflected by the second reflective sheet 32 and then re-entered into the light guide plate 2, and further increase the reflectivity of the reflective sheet 3. At this time, the second reflective sheet 32 can improve the reflectivity and utilization rate of the light.

The optical film set 1 can be attached to a top surface and the side surface of the light guide plate 2 with a transparent double-sided tape or glue.

The optical film set 1 comprises a first optical film set 11 and a second optical film set 12 that are integrated with each other (see FIG. 2). The first optical film set 11 is attached to the top surface (light-emitting surface) of the light guide plate 2, and the second optical film set 12 is bent and attached to an outer surface of the second reflective sheet 32. The second optical film set 12 is perpendicular to the first optical film set 11 and forms a L-shaped optical film set with the first optical film set 11. After the second optical film set 12 is bonded to the outer surface of the second reflective sheet 32 by the transparent double-sided tape or the glue, the optical film set 1 is fixed to the light guide plate 2. The second optical film set 12 allows light to pass through on the side of the display panel, enhances the brightness at the edge of the display panel, and improves the brightness and uniformity of the display panel.

The second optical film set 12 comprises a first optical film 101, a second optical film 102, and a third optical film 103.

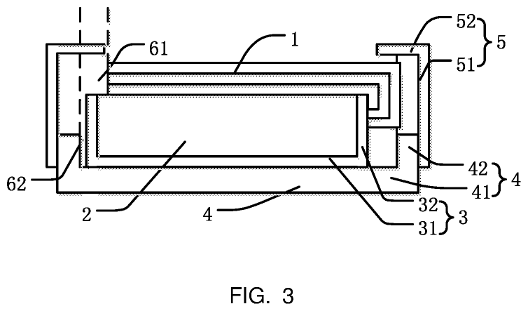

In the embodiment, bottoms of the first optical film 101, the second optical film 102, and the third optical film 103 are on the same line. In other embodiments, the bottoms of the first optical film 101, the second optical film 102, and the third optical film 103 may not be on the same line. As shown in FIG. 3, the bottom of the second optical film 102 is lower than the bottom of the first optical film 101, and the bottom of the second optical film 102 is fixed to an outer surface of the second reflective sheet 32. The bottom of the third optical film 103 is lower than the bottom of the second optical film 102, and the bottom of the third optical film 103 is fixed to the outer surface of the second reflective sheet 32.

The second optical film set 12 can be disposed on one or two sides of the light guide plate 2, but cannot be disposed on two parallel sides of the light guide plate 2 at the same time. It is necessary to ensure that the second optical film set 12 disposed on at least one of the two parallel sides is in a fixed state to prevent the optical film set 1 from slipping.

The optical film set 1 comprises a multilayer optical film, which may comprise a diffusion sheet, a lower brightness enhancement sheet, an upper brightness enhancement sheet, and the like. In the embodiment, a three-layer optical film is preferred. The first optical film 101 is a diffusion sheet 101, the second optical film 102 is a lower brightness enhancement sheet 102, and the third optical film 103 is an upper brightness enhancement sheet 103.

The diffusion sheet is attached to the top surface (light-emitting surface) of the light guide plate 2, and comprises a diffusion sheet extension. The diffusion sheet extension is attached to one side of the light guide plate 2. The diffusion sheet 101 is used for atomizing light emitted from the light-emitting surface, homogenizing the scattered light source, improving the uniformity of the light, and dispersing side light to a front surface, thereby improving the brightness of the front surface of the display panel.

The lower brightness enhancement sheet is attached to an upper surface of the diffusion sheet, and comprises a lower brightness enhancement sheet extension. The lower brightness enhancement sheet extension is attached to an outer surface of the diffusion sheet extension. The lower brightness enhancement sheet acts to concentrate the light in the light source to enhance a luminous flux.

The upper brightness enhancement sheet is attached to an upper surface of the lower brightness enhancement sheet, and comprises an upper brightness enhancement sheet extension. The upper brightness enhancement sheet extension is attached to an outer surface of the lower brightness enhancement sheet. The upper brightness enhancement sheet acts to concentrate the light in the light source to enhance the luminous flux.

The backlight module described in the embodiment is a side-in backlight module. The light source (not shown) is disposed on a left side of the light guide plate 2 as shown in FIG. 1, and the light source is directly facing a light incident surface of the light guide plate 2. The optical film set 1 is attached to the light emitting surface of the light guide plate 2. After the light is emitted from the light source, the light enters to the light guide plate 2. The light incident under the light guide plate 2 is reflected by the first reflective sheet 31 and then emitted from the light exit surface of the light guide plate 2. The light incident on the side surface of the light guide plate 2 is reflected by the second reflective sheet 32 one or more times, then emitted from the light exit surface of the light guide plate 2, and the light emitted from the light exit surface is diffused by the optical film set 1. The concentrating performance of the backlight module is further enhanced, and the brightness and uniformity of the display panel are further improved.

The bottom plate 4 comprise a first bottom plate 41 and a second bottom plate 42. The first bottom plate 41 is attached to a bottom surface of the first reflective sheet 31. The second bottom plate 42 is disposed on an outer side of the second reflective sheet 32, and the second bottom plate 42 is opposite to the second reflective sheet 32. That is, the second bottom plate 42 is parallel to the second reflective sheet 32 and perpendicular to the first bottom plate 41, and forms a L-shaped bottom plate with the first bottom plate 41. The bottom plate 4 functions to protect the backlight module. The bottom plate 4 is made of metal, and the bottom plate 4 can be directly formed or stamped in a L-shaped mold.

A top surface of the second bottom plate 42 is disposed below the bottom of the second optical film set 12 to prevent damage to the optical film set.

The second reflective sheet 32 is perpendicular to the first reflective sheet 31, and/or the second optical film set 12 is perpendicular to the first optical film set 11, and/or the second bottom plate 42 is perpendicular to the first bottom plate 41 and parallel to one side of the light guide plate 2. In the embodiment, the second reflective sheet 32 is perpendicular to the first reflective sheet 31, the second optical film set 12 is perpendicular to the first optical film set 11, and the second bottom plate 42 is perpendicular to the first bottom plate 41 and parallel to one side of the light guide plate 2.

The frame 5 is connected to the bottom plate 4 to protect the backlight module. The frame 5 comprises a first frame 51 and a second frame 52 that are integrated with each other.

The first frame 51 is opposite to the second reflective sheet 32, and the second frame 52 is opposite to the first bottom plate 41. It can be considered that an upper end of the first frame 51 is bent and extends above the optical film set 1, and the second frame 52 is parallel to the first optical film set 11. However, an end of the second frame 52 cannot extend directly above the light guide plate 2, otherwise a range of light emission is affected, and the brightness range of the display panel is further affected.

A first gap 61 is disposed between the frame 5 and the first optical film set 11. A width of the first gap 61 is greater than a thickness of the second reflective sheet 32, and the width of the first gap 61 is smaller than a width of a gap between the first frame 51 and the second reflective sheet 32. The width of the first gap 61 is in the order of millimeters. When the optical film set 1 is affected by high temperature, one end of the optical film set 1 enters to the first gap 61, so that the optical film set 1 is kept flat and always attached to the light-emitting surface of the light guide plate 2, and thus the light in the light guide plate 2 can be normally transmitted through the optical film set 1.

A second gap 62 is disposed between the second bottom plate 42 and the second reflective sheet 31. The second gap 62 communicates with the first gap 61, and the second gap 62 provides spaces for the outward expansion of the second reflective sheet 32.

The display panel of the present embodiment can be used in a field of an in-vehicle display, and needs to withstand a test of high temperature during use. The optical film set 1 is easily expanded at a high temperature, and a gap is added on one side of the optical film set 1, so that the optical film set 1 is kept flat and attached to the light-emitting surface of the light guide plate 2, thereby ensuring that the light in the light guide plate 2 is normally transmitted through the optical film set 1.

The technical effect of the display panel of the embodiment is to provide the gaps between the bottom plate and the optical film set, and between the frame and the optical film set. After the thermal expansion of the optical film set, one end of the elongated optical film set enters to the gaps, so that the optical film set is kept flat, and is attached to a light-emitting surface of the light guide plate to ensure that the light from the light guide plate is normally transmitted through the optical film set. Further, the present invention can also extend the service life of the optical film set, thereby extending the service life of the in-vehicle display panel.

In the above, various other corresponding changes and modifications can be made according to the technical solutions and technical ideas of the present invention to those skilled in the art, and all such changes and modifications are within the scope of the claims of the present invention.

What is claimed is:

1. A backlight module, comprising:
an optical film set, a light guide plate, a reflective sheet, and a bottom plate in turn, and further comprising:
a frame connected to the bottom plate and disposed opposite to a side of the light guide plate;
wherein a gap is present between one end of the optical film set and the frame.

2. The backlight module as claimed in claim 1, wherein the reflective sheet comprises a first reflective sheet and a second reflective sheet that are integrated with each other;
wherein the first reflective sheet is attached to a bottom surface of the light guide plate; and
the second reflective sheet is attached to a side of the light guide plate and is disposed opposite to the frame.

3. The backlight module as claimed in claim 2, wherein the optical film set comprises a first optical film set and a second optical film set that are integrated with each other;
wherein the first optical film set is attached to a top surface of the light guide plate; and
the second optical film set is attached to an outer surface of the second reflective sheet.

4. The backlight module as claimed in claim 3, wherein the gap is disposed on a side of the first optical film set and opposite to the second optical film set.

5. The backlight module as claimed in claim 2, wherein a width of the gap is greater than a thickness of the second reflective sheet, and the width of the gap is smaller than a width of a gap between the frame and the second reflective sheet.

6. The backlight module as claimed in claim 1, wherein the optical film set comprises:
a first optical film attached to a surface of the light guide plate away from a side of the reflective sheet and extending to a side of the light guide plate;
a second optical film attached to an outer surface of the first optical film; and
a third optical film attached to an outer surface of the second optical film.

7. The backlight module as claimed in claim 6, wherein bottoms of the first optical film, the second optical film, and the third optical film are on the same line.

8. The backlight module as claimed in claim 6, wherein a bottom of the second optical film is lower than a bottom of the first optical film, and the bottom of the second optical film is fixed to an outer surface of the second reflective sheet; and
a bottom of the third optical film is lower than the bottom of the second optical film, and the bottom of the third optical film is fixed to the outer surface of the second reflective sheet.

9. The backlight module as claimed in claim 2, wherein the bottom plate comprises:
a first bottom plate attached to a bottom surface of the reflective sheet; and
a second bottom plate disposed on an outer side of the second reflective sheet and disposed opposite to the second reflective sheet.

10. A display panel, comprising a backlight module as claimed in claim 1.
